(19) United States
(12) Patent Application Publication
(10) Pub. No.: US 2008/0196794 A1
(43) Pub. Date: Aug. 21, 2008

(54) BULK METALLIC GLASS/METAL COMPOSITES PRODUCED BY CODEFORMATION

(75) Inventors: Jean-Jacques BLANDIN, Le Champ Pres Froges (FR); Michel Suery, Colombe (FR); Gilles Boutet, Saint-Ismier (FR); Sebastien Gravier, Frahier (FR); Sylvain Puech, Grenoble (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Centre National de la Recherche Scientifique Institut National Polytechnique de Grenoble

(21) Appl. No.: 12/034,100

(22) Filed: Feb. 20, 2008

Related U.S. Application Data
(60) Provisional application No. 60/890,635, filed on Feb. 20, 2007.

(51) Int. Cl. C22F 1/00; C22C 45/00; C21D 9/00; B32B 15/01

(52) U.S. Cl. 148/522; 148/527; 148/403

(57) ABSTRACT

The invention is related to bulk metallic glass/metal alloys, a method for their production and their uses. Especially, the invention is concerned with composite materials resulting from the co-deformation of a bulk metallic glass and a metal.

More specifically the method for the production of a composite of at least one bulk metallic glass and at least one metal, comprises the step of co-deforming the bulk metallic glass and the metal at a temperature comprised in the supercooled liquid region of the bulk metallic glass.

The invention is related to bulk metallic glass/metal alloys, a method for their production and their uses. Especially, the invention is concerned with composite materials resulting from the co-deformation of a bulk metallic glass and a metal.

Bulk metallic glasses (BMGs) are very promising materials since they display spectacular mechanical properties such as a large elastic domain associated with particularly high fracture stresses [J. F. Löffler, Intermetallics, 2003, 11, 529].

In the recent past, there has been a growing use of BMGs in various industrial sectors, as defence, sport, medicine, microelectronics or telecommunications.

Bulk metallic glasses (BMGs) have particularly interesting mechanical properties:

i) at ambient temperature, the elastic strain is very high, especially compared to that of conventional metal alloys, and their strength is higher than that of ceramics.

ii) beyond their glass transition temperature, their deformability becomes extremely high (just like some polymers and some oxide glasses).

These characteristics render these materials of high interest for the production of items with high mechanical specifications, said production employing a method which does not require machining.

A new application of bulk metallic glasses, which is the object of the invention, consists in using them as reinforcement in conventional alloys in order to take advantage of the high strength of the glass and of the large ductility of the alloy in the same way as in ceramic fibre reinforced alloys. One of the aims of the invention was to obtain materials possessing the mechanical properties of bulk metallic glasses and the ductility of metals. Such composite materials could be used to produce also electricity conducting structures.

Metal reinforced bulk metallic glasses are known [H. Li et al., Mater. Sc. Eng., A403 (2005) 134; G. Wang et al., J Non Cryst. Solids, 2006 352 3872; P. Wadhwa et al., Scripta Mater., 2007 56 73]. Such materials can be used for instance as heat exchangers or in defence applications like kinetic energy penetrators due to self-sharpening behaviour. (ballistic . . . ). They are produced frequently by infiltration of the reinforcement perform by the BMG in the liquid state. However, such methods have frequently to manage reactions between the metallic reinforcement and the liquid metallic glass.

Ceramic fibre reinforced materials have been extensively studied in recent years and they are particularly interesting for several applications, mainly in aeronautic and aerospace industries. Such materials are disclosed in WO2005/230029. However, the processing costs of such composites are extremely high (high temperature and pressure). Unexpected chemical reactions occur between the ceramic reinforcement and the metal, which makes it necessary to coat the ceramic reinforcement. As a result, the process is more complicated and costly than expected.

In order to remedy these problems, the inventors have developed a new method for the production of a bulk metallic glass/metal alloy by co-deformation of the bulk metallic glass and the metal.

This method permits to associate, in a same composite material, a metal or a light metal alloy and a bulk metallic glass. This method relies on a step of co-deformation of both materials at a low temperature, which is not too costly with regards to energy supply.

Until now, the feasibility of reinforcing conventional alloys with bulk metallic glasses was not yet demonstrated and we have shown that such a combination provides interesting properties in terms of elasticity, strength and ductility.

The method that we have found rests on co-deformation of the bulk metallic glass and the metal at a temperature of the glass low enough to avoid crystallisation but high enough to allow bonding with the alloy. Such conditions can be fulfilled in the supercooled liquid region (SLR) of the glass, i.e. beyond the glass transition temperature where bulk metallic glasses exhibit a particularly large formability. The idea is therefore to take advantage of this behaviour to allow incorporating the bulk metallic glass into a conventional alloy by using for example co-extrusion of the two materials at a temperature corresponding to the SLR of the glass. In such conditions of processing, flowing conditions of the two materials should be close enough so that co-deformation occurs harmoniously.

One object of the invention therefore is a method for the production of a composite of at least one bulk metallic glass and at least one metal, wherein said method comprises the step of co-deforming the bulk metallic glass and the metal at a temperature comprised in the supercooled liquid region (SLR) of the glass.

By co-deforming is meant deforming together, in conditions such that both materials are in close contact with each other and are subjected to the same conditions of temperature and pressure (or strain rate) permitting their concomitant deformation. Among co-deforming methods, one can mention: co-extruding, co-pressing and co-laminating.

Co-extrusion is a process which has been developed quite extensively to manufacture bimetallic rods and tubes. Both theoretical and experimental works have been performed [R. Sliwa, J. Mat. Proc. Technol., 1997, 67, 29; P. Kazanowski, M. E. Epler, W. Z. Misiolek, Mater. Sc. Eng., 2004, A369, 170] and it has been shown that the flow characteristics of the two metals depend on many factors related to the geometry of the process and to the flow behaviour of the individual metals [B. Avitzur, Handbook of Metal-Forming Processes, John Wiley & Sons, USA, 1983, 419.]. In particular the extrusion ratio, the die angle, the friction coefficient between the billet and the container, the ratio of the core and sleeve flow stress and the initial bond strength between the two metals are particularly important factors controlling the process. Bimetallic co-extrusion has been developed also to manufacture commercial superconductors for power applications.

Co-pressing is a method which has been developed to produce assemblies of parts involving frequently diffusion bonding [Somekawa et al., Scripta Mater., 2003 48 1249] [Somekawa et al., Mater. Sc. Eng., 2003 A339 328]. Two or more pieces (generally sheets) of materials identical or different are introduced in a press and subjected to a pressure while heated at a selected temperature.

Co-laminating is a method which has been developed to produce ultra fine grained metallic alloys (i.e. by accumulative roll bonding) [Huang et al., Mater. Sc. Eng., 2003 A340 265] [Del Valle et al., Mater. Sc. Eng. 2005 A410-411 353] or metallic laminates [Min et al., 2006 60 3255; Zhang et al., Mater. Sc. Eng., A 2007, doi: 10.1016/j.msea.2006.06.144]. Two or more sheets of materials, identical or different, are heated at a selected temperature and then introduced between two rolls and applied a pressure so that they will deform together. Laminating successively between several couples of rolls can be arranged.

The content of those documents is incorporated by reference.

Co-extrusion is the first favourite mode of performing the invention.

Co-pressing is the second favourite mode of performing the invention.

Co-laminating is the third favourite mode of performing the invention.

Bulk metallic glass or metallic glass means a glass exclusively composed of metal elements. Such materials are well known to the skilled professional and have been described by many authors: A. Inoue, Acta Mater., 2000 48 279; M. D. Demetriou, W. L. Johnson, Acta Mater., 2004 52 3403; Y. Kawamura et al., Mat. Sci. Eng., 2001 A304-306 674; T. G. Nieh et al., Acta Mater., 2001 49 2887; B. van Aken et al., Mat. Sci. Eng., 2000 A278 247; A. V. Sergueeva et al., J Non Cryst. Solids, 2003 317 169; M. Bletry et al., Acta Mater., 2006 54 1257; M. Bletry et al., Mater Sci. Eng., 2004 A387-389 1005; Q. Wang et al., J Non-Cryst. Solids, 2005 351 2224. The content of those documents is incorporated by reference.

Bulk metallic glasses usable in the present invention can be selected from those based on any metal like: Mg, Zr, Fe, Pd, Cu, Ti, Ni, Ca, Pd, Mo, Cr, Co, Pt, Gd, La, Ce . . . . Preferably, one selects bulk metallic glasses based on: Zr, Mg, Ti, Fe, Ni, Cu.

A bulk metallic glass based on a metal M is a bulk metallic glass wherein said metal is the majority element. This majority is a relative one. Secondary elements are usually selected in the same list of metals as the majority element and as depicted above. Metallic glasses generally comprise 2 to 6 elements; usually they comprise 3, 4 or 5 elements.

Metals which can be used in the present invention are any metals or metal alloys. Wrought metals and wrought alloys are preferred, but foundry metals and foundry alloys can also be used in some cases. By definition, an alloy based on one metal usually contains more than 90% of that metal.

The choice of the metal is guided by the final application. If the application of the composite material is electricity or electronics, then the Al, Mg and Cu based alloys should be preferred.

Finally, the metal should be deformable at a temperature comprised in the supercooled liquid region (SLR) of the metallic glass. The hot deformation of a metal or a metal alloy is generally performed at a temperature T_{d}, expressed in Kelvin, which is comprised between 0.4 Tₘ and 0.6 Tₘ, wherein Tₘ is the melting temperature of this metal expressed in Kelvin.

The melting temperature Tₘ of the metal, expressed in Kelvin, and the glass transition temperature, T_{g}, of the metallic glass, also in Kelvin, should satisfy the following relationship:

0.4 Tₘ≦T_{g}≦0.6 Tₘ

The supercooled liquid region of the metallic glass is the temperature range which starts from the glass transition temperature of the metallic glass and which ends at the crystallisation temperature of the same metallic glass.

Glass transition temperature and crystallisation temperature of many metallic glasses are known to the skilled professional from the literature [cf. review of Wang et al., Mater. Sc. Eng. Report, (2004), 44, 45-89].

The content of those documents is incorporated by reference. For metallic glasses which have not yet been reported in the literature, we give a method of determining their glass transition temperature and crystallisation temperature: these temperatures can be determined by differential scanning calorimetry (DSC) in continuous heating conditions for which any endothermic or exothermic reaction can be detected.

Advantageously, in order to obtain a “harmonious” deformation of both materials and in order to prevent the formation of cracks at the interface between both materials, it is recommended to select the bulk metallic glass and the metal so that their viscosities are relatively similar. For instance, the bulk metallic glass having a viscosity V_{MG} at the temperature at which the co-deformation will be performed, it is recommended to select a metal or a metal alloy such that, at the temperature at which the co-deformation will be performed, its viscosity V_{M} (expressed in the same units as V_{MG}) satisfies the relationship:

V_{MG}/10≦V_{M}≦10V_{MG}

Even more preferably, the bulk metallic glass and the metal are selected to satisfy the relationship:

V_{MG}/5≦V_{M}≦5V_{MG}

According to a favourite method of performing the invention, the bulk metallic glass and the metal are selected to satisfy the relationship:

V_{MG}/2≦V_{M}≦2V_{MG}

Another parameter which should be taken into account is the rate, or the duration, of co-deformation. Actually, if the co-deformation is performed too slowly, there is a risk that the metallic glass may crystallise during the process, which of course should be avoided. The rate of co-deformation cannot be dissociated from the temperature at which co-deformation is performed. When co-deformation is performed at a temperature very close to the transition glass temperature, then the duration of the process can be very long, typically greater than one hour. If co-deformation is performed at a temperature closer to the crystallisation temperature, then the duration of the process should be very short, typically less than several minutes. Deformation rate also has an influence on the viscosity of the glass metal and the metal. The sensitivity of the glass metal and the metal to the deformation rate, with regards to their viscosity is not identical. The relationship between the speed of co-deformation and the temperature of co-deformation is not linear and should be adapted by the skilled professional by using his general knowledge and by appropriate testing methods: The dependency of the viscosity upon the strain rate can for instance be deduced from compression tests performed at various temperatures.

According to a first variant, the method of the invention is performed by introducing the glass metal and the metal in the extrusion device at an appropriate temperature and co-extruding the composite. Advantageously, the method comprises:

(a) casting filaments or rods or tapes of bulk metallic glass,

(b) machining at least one hole in a metal rod or in a metal plate, along the central axis of the rod, or the central plane of the plate,

(c) heating the extrusion device to a temperature comprised in the supercooled liquid region (SLR) of the glass,

(d) introducing the rod(s) or tape(s) of glass metal into the metal rod or plate,

(e) introducing the item obtained at (d) into the extrusion device,

(f) co-extruding a glass metal/metal composite.

In a more general manner, it is possible to use any co-extrusion method known to the skilled professional and disclosed for example in: P. Kazanowki et al., Mater. Sc. Eng., 2004, A369, 170; A. Daoud, Mater. Sc. Eng., 2005, A391, 114; M. Mizumoto et al., Mater. Sc. Eng., 2005, A413-414, 521; L. G. Chen et al., Comp. Sc. Tech., 2005, 66, 1793; T. W. Kim, Mater. Lett., 2005, 59, 143; R. A. Sanguinetti Ferreira et al., Composites A, 2005, 37, 1831; A. Klaus et al., Light Metal Age, 2004, 12; K. A. Weidenmann et al., Light Metal Age, 2005, 6.

Especially, it can be foreseen to extrude a composite item of any possible shape accessible by an extrusion process by using the appropriate extrusion die. One can extrude cylindrical metal rods comprising a glass metal core. One can also extrude cylindrical metal rods comprising several parallel glass metal fibers included therein. One can also extrude together several cylindrical metal rods comprising a glass metal core so that a multi-filamentary structure composite is formed. One can also extrude a plate of metal comprising a glass metal plate in its core.

According to a second variant, the method of the invention is performed by introducing the glass metal and the metal in a press at an appropriate temperature and co-pressing the composite. Advantageously, the method comprises:

(a) casting filaments or rods or tapes of bulk metallic glass,

(b) heating the press to a temperature comprised in the supercooled liquid region (SLR) of the glass,

(c) stacking alternatively one or several rod(s) or tape(s) of glass metal with metal rod or plate(s),

(d) introducing the item obtained at (c) into the press,

(e) co-pressing of a glass metal/metal composite.

According to another variant, the method comprises

(a) casting filaments or rods or tapes or plates of bulk metallic glass,

(b) casting a metal plate,

(c) heating the press to a temperature comprised in the supercooled liquid region (SLR) of the glass,

(d) stacking alternatively one or several rod(s) or tape(s) of glass metal with metal rod or plate(s),

(e) introducing the item obtained at (d) into the press,

(f) co-pressing of a glass metal/metal composite.

In a more general manner, it is possible to use any co-pressing method known to the skilled professional and disclosed for example in [Somekawa et al., Scripta Mater., 2003 48 1249; Somekawa et al., 2003 A339 328].

Such operation of pressing can be repeated several times, so that several composite structures are produced which can then be used as starting material in the same co-pressing method. Thus multi filamentary composite structures or multi-layer composite structures can be obtained.

According to a fourth variant, the method of the invention is performed by introducing the glass metal and the metal in a rolling mill at an appropriate temperature and co-laminating the composite. Advantageously, the method comprises:

(a) casting plates of bulk metallic glass,

(b) casting metal plates,

(c) heating the metal and glass metal plates to a temperature comprised in the supercooled liquid region (SLR) of the glass,

(d) introducing the plates of glass metal between two metal plates,

(e) introducing the item obtained at (d) between the rolls,

(f) co-laminating of a glass metal/metal composite.

In a more general manner, it is possible to use any co-laminating method known to the skilled professional and disclosed for example in [Huang et al., Mater. Sc. Eng., 2003 A340 265; Del Valle et al., Mater. Sc. Eng., 2005 A410-411 353] or metallic laminates [Min et al., Mater. Lett., 2006 60 3255; Zhang et al., Mater. Sc. Eng. A, 2007, doi: 10.1016/j.msea.2006.06.144].

Such operation of laminating can be repeated several times, so that several composite structures are produced which can then be used as starting material in the same co-laminating method. Thus multi-layer composite structures can be obtained.

Another object of the invention is a composite material resulting from the co-deformation of a bulk metallic glass and a metal, wherein the bulk metallic glass and the metal have been selected as has been above disclosed.

Especially, the invention is concerned by a core/sleeve composite material comprising a bulk metallic glass core and a metal sleeve. The invention is also concerned by a composite material comprising several parallel bulk metallic glass cores and a metal sleeve. The shape of the composite material is any shape that can be obtained by a method of extrusion or pressing or laminating. The bulk metallic core(s) preferably has an axis of symmetry parallel to the axis or plane of symmetry of the metal sleeve.

Such configuration can for example be any of those detailed here-under:
a rod consisting of an approximately cylindrical bulk metallic glass core enveloped by a metal sleeve, like illustrated on FIGS. 1 and 2A to 2D.
A metal rod (1) comprising a plurality of parallel bulk metallic glass filaments (2) in a metal sleeve (3), like illustrated on FIGS. 7A (3 filaments) and 7B (5 filaments).
A sandwich structure (4) composed of two or more metal plates (5) and a bulk metallic glass plate (6) included in between the metal plates (FIG. 8).
A composite structure (8) composed of two or more metal plates (9) and parallel bulk metallic glass rods (10) inserted in between the metal plates (FIG. 9).
A composite structure composed of one metal plate and a bulk metallic glass plate coated on the metal plate (FIG. 17).

Those structures are given as examples of realisation of the invention and should not be considered as limitative.

Another object of the invention is an electricity conducting structure including a composite material as disclosed above, especially a composite material comprising a bulk metallic glass core and a metal sleeve.

### EXPERIMENTAL PART

Two families of bulk metallic glasses were selected for this investigation:

The Zr-based BMG family includes two compositions, called BMG 1 and BMG 3. The Zr based BMG1 responds to formula Zr_{41.2}Ti_{13.8}Cu_{12.5}Ni_{10.0}Be_{22.5}. It was supplied by Howmet Corp (USA) in the form of a sheet of 3 mm thickness. The Zr-based BMG 3 responds to formula Zr_{52.5}Ti_{2.5}Cu₂₇Ni₈Al₁₀. It was elaborated in the form of ribbons with a thickness of about 50 microns according to the method disclosed here-under.

The Mg-based BMG called BMG 2 responds to formula Mg₆₅Cu₂₅Gd₁₀. It was elaborated in the form of 4 mm diameter rods according to the method disclosed here-under.

### I—FIGURES

FIG. 1: metal rod of composite material Bulk Metallic Glass/alloy obtained by extrusion; top specimen: BMG 1/Al ; bottom specimen: BMG 2/Al FIG. 2: electronic microscopy observation of transversal sections of rods a. BMG 1/Al-5056 b. BMG 1/Mg-AZ31 c. BMG 2/Al-5056 d. BMG 2/Mg-AZ31

FIG. 3: scanning electronic microscopy observation of Bulk Metallic Glass/alloy interfaces in composite materials a. BMG 1/Al-5056 b. BMG 1/Mg-AZ31 c. BMG 2/Al-5056 d. BMG 2/Mg-AZ31

FIG. 4: variation of the thickness of the Al-5056 sleeve along the BMG 1/Al MeGA rod.

FIG. 5: comparison of viscosities of BMG 1 and of the alloys Al-5056 and Mg AZ31 at 646 K

FIG. 6: comparison of viscosities of BMG 2 and of the alloys Al-5056 and Mg AZ31 at 423 K

FIGS. 7 to 9 schematically illustrate different structures which can be obtained by the above-disclosed method.

FIG. 10: Optical micrograph observations of the cross sections of the co-extruded Al 5056/BMG 1 co-extruded rods after one, two and three extrusions.

FIG. 11: Optical micrograph observation of the Al 5056/BMG 1 interface after one, two and three extrusions.

FIG. 12: Optical micrograph observation of the cross sections of the co-extruded Al 5056/BMG 2 co-extruded rods after one, two and three extrusions.

FIG. 13: Photograph of a co-extruded composite with a rectangular shaped extrusion die.

FIG. 14: Optical micrograph observation of the cross section of a rectangular shaped co-extruded composite (Mg-AZ31/BMG2)

FIG. 15: Optical micrograph observation of a Al-5056/BMG3/Al-5056 co-pressed material.

FIG. 16: Optical micrograph observation of a Al-5056/BMG3/Al-5056/BMG3/Al-5056 co pressed material.

FIG. 17: Optical micrograph observation of co-pressed material in the case of stacking often Al-5056 plates with BMG3 ribbons in between

FIG. 18: Optical micrograph observation of a BMG3 coating on an Al substrate.

FIG. 19: Optical micrograph observation at higher magnification of a BMG3 coating on an Al substrate.

### II—METHODS

Production of BMG2=Mg₆₅Cu₂₅Gd₁₀

For this glass, elements with purity better than 99.9% were used as starting materials. Cu—Gd was prepared as an intermediate alloy prior to be re-melted with Mg to obtain the master alloy, in the appropriate proportions of metals. The glass rods were prepared by casting the melt in a copper mould with a 4 mm diameter. The amorphous nature of the alloy was confirmed by X-Ray diffractometry (XRD) with CuKα radiation and differential scanning calorimetry (DSC) carried out with a heating rate of 10 K/min.

Production of BMG3=Zr_{52.5}Ti_{2.5}Cu₂₇Ni₈Al₁₀

The pure metals (with purity better than 99.9%) were melted in a cold crucible and the alloy was cast on a rotating cold metallic wheel to produce the ribbon by the so-called melt spinning technique.

Characterisation of Bulk Metallic Glasses

The glass transition temperature T_{g}, the temperature of the first crystallization peak Tₓ and the Supercooled Liquid Region (SLR) ΔT(=Tₓ−T_{g}) were measured and the corresponding values for the two studied glasses are given in table I here-under:

TABLE I
Characteristic temperatures of bulk metallic glasses BMG 1,
BMG 2 and BMG 3

| Bulk metallic glass | T_{g} (K) | Tₓ (K) | ΔT (K) |
|---|---|---|---|
| Zr_{41,2}Ti_{13,8}Cu_{12,5}Ni_{10,0}Be_{22,5} (BMG 1) | 628 | 708 | 80 |
| Zr_{52.5}Ti_{2.5}Cu₂₇Ni₈Al₁₀ (BMG 3) | 678 | 746 | 68 |
| Mg₆₅Cu₂₅Gd₁₀ (BMG 2) | 417 | 472 | 55 |

Extrusion Temperatures:

From these data, the temperatures of extrusion have been selected at 646 K and 423 K for the Zr and the Mg-based BMGs respectively. These temperatures were chosen in order to be higher than the glass transition temperatures of the glasses but also in order to preserve the amorphous character of the alloy during the extrusion process. Indeed, it was previously shown that no significant structural changes occurred in the BMG 1 for maintain times smaller than about 1800 s. at 646 K [Q. Wang et al. J Non-Cryst. Solids, 2005, 351, 2224]. For the BMG 2 alloy, the allowed time window at 423 K was even longer, close to 5000 s [J. L. Soubeyroux et al. J. All. Comp., 2006doi: 10.1016/j.jallcom.2006.08.297].

### Metal Alloys:

Two alloys were used as sleeves in this study: recovered Al-5056 alloy in the form of 10 mm diameter extruded bar and AZ31 magnesium alloy in the form of 10 mm thick plate obtained by hot rolling. The compositions of these alloys are given in table II.

TABLE II
Alloys composition

| Matrix | Al | Mg | Zn | Mn | Cu |
|---|---|---|---|---|---|
| Al-5056 | Bal. | 5.0 | — | 0.1 | 0.1 |
| Mg-AZ31 | 3.0 | Bal. | 1.0 | 0.3 | — |

In table II, balance is at 100.

### Extrusion Device:

The diameter of the container of the extrusion device was equal to 7 mm and the conical die with an angle equal to 45° is 3 mm in diameter. The extrusion ratio was thus equal to 5.4. The specimen to be extruded consisted in a cylinder of Al-5056 or Mg-AZ31 in which a non emerging 2.5 mm or 4 mm (for BMG1 and BMG2 respectively) hole was drilled and filled with a machined glass rod. For each test, the specimen was introduced in the container when the extrusion temperature was reached and stabilized in the device. After this introduction, less than five minutes was required to homogenize the temperature before starting the extrusion. Depending on the extruded materials and on the extruded length, the ram speed was between 0.1 mm/min and 1 mm/min. After extrusion, the rods were characterised by SEM observations, with a particular attention given to the quality of the interfaces and to the diameter variation of the glass cores along the rods. Microhardness as well as compression tests at room temperature were also carried out to evaluate the mechanical properties of the rods. In order to get information about the rheological behaviour of the various constituent materials at the temperatures of extrusion, compression tests at 423 K and 646 K were also performed in air. The samples were heated to the given testing temperature at a heating rate of about 10 K/min and a minimum maintain of about 300 s was necessary to homogenize the temperature before starting the compression test.

Production of Multi-Filamentary Composites Al 5056/BMG 1 and Al 5056/BMG 2:

In the case of the Al 5056/BMG 1 co-extruded material, the operation of extrusion was repeated twice (at the same temperature equal to 646 K and at the same ram speed) in order to produce a multi-filamentary composite. For this purpose, the second extrusion was carried out by using a cylinder of Al-5056 of 7 mm in diameter in which three non emerging holes were drilled and filled with pieces cut from the rod resulting from the first extrusion. The similar procedure was employed for the third extrusion.

Similar experiments were also carried out with BMG2 as filaments. In this case, co-extrusion steps were carried out at 423 K and with a ram speed equal to 0.3 mm/min.

Co-extrusion of Mg-AZ31/BMG2 with a Die of Rectangular Shape

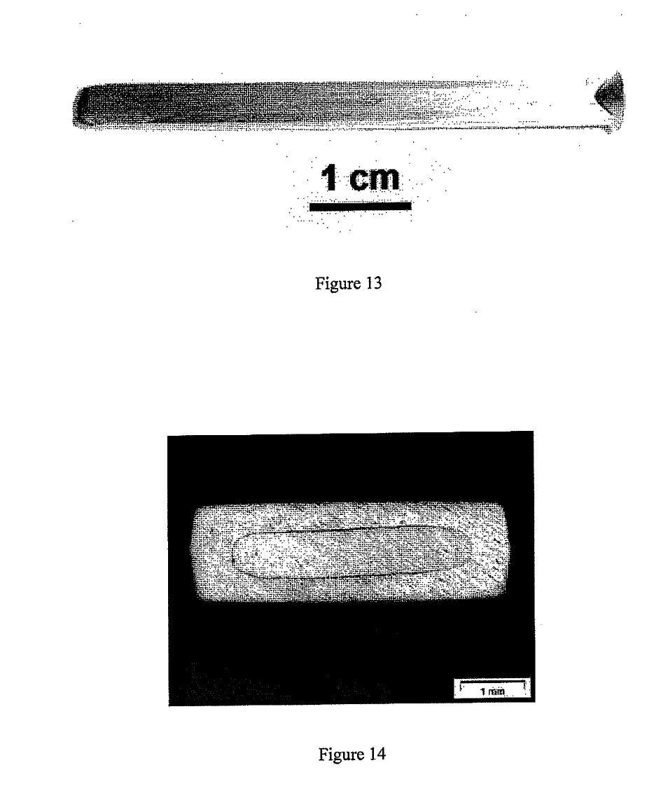

Co-extrusion can be performed also by using extrusion dies with other shapes. An illustration of this possibility is shown in FIG. 13 in the case of a rectangular shaped die. The dimensions of the extrusion die are 5×1.5 mm². This corresponds to the same extrusion ratio Rₑ as the ratio used for the other co-extrusion steps (Rₑ≈5).

Co-Pressing of Al-5056 with BMG3

For the co-pressing test, a zirconium based metallic glass corresponding to the formula Zr_{52.5}Cu₂₇Al₁₀Ni₈Ti_{2.5} (BMG3) was used in the form of a ribbon of 50 μm thickness. From the characteristic temperatures of this glass, the temperatures of pressing were selected between 643 K and 698 K. As for co-extrusion, this temperature interval was chosen in order to preserve the amorphous character of the alloy during the co-pressing step. For co-pressing, square (5×5 mm 2) plates of Al-5056 of given thicknesses were used with piece(s) of ribbon of similar surface in between. Tests were carried out with three configurations:
two plates of Al-5056 of 3 mm thickness with one piece of ribbon in between
three plates of Al-5056 of 3 mm thickness with one piece of ribbon between each of them
ten plates of Al-5056 of 1 mm thickness (this thickness was obtained by grinding the plate of 3 mm thickness) with one piece of ribbon between each of them.

The surfaces of the Al plate and of the ribbon were polished up to 1200 grid SiC paper. The ribbon(s) was(were) then placed between the Al plates. The assembly was introduced in the furnace and then heated at 10° C./min. up to the temperature of pressing. The temperature was homogenized for 5 minutes and the assembly was deformed in compression at a constant strain rate of 2.5×10⁻⁴ S⁻¹. This strain rate was chosen so that a significant strain (the illustrations shown below correspond to a strain equal to −0.5 in compression) is reached after a time which preserves the amorphous structure of the glass at the selected temperature.

Co-Pressing of Al-5056 with BMG1:

Co-pressing can also be used as a process to get a BMG coating on a metallic substrate. An example of this technology is displayed by FIG. 18 in the case of a coating of BMG1 on an Al-5056 substrate. A square (5×5 mm2) plate of Al-5056 of 2 mm thickness was used together with a piece of ribbon of similar surface.

The preparation of the surfaces was the same as for Al/BMG/Al composites. The assembly was introduced in the furnace and heated at 10° C./min up to 693 K. After 5 min homogenization, the assembly was deformed in compression at a strain rate of 2.5×10⁻⁴ s⁻¹ to produce a strain of −0.5 in 2000 s.

### III—RESULTS

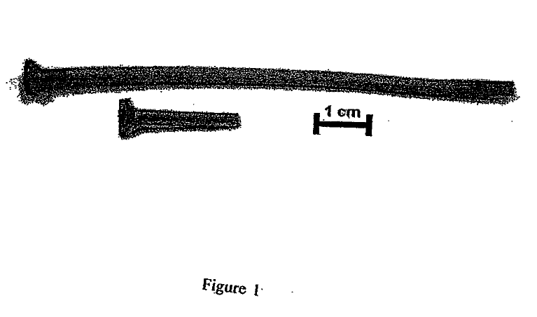

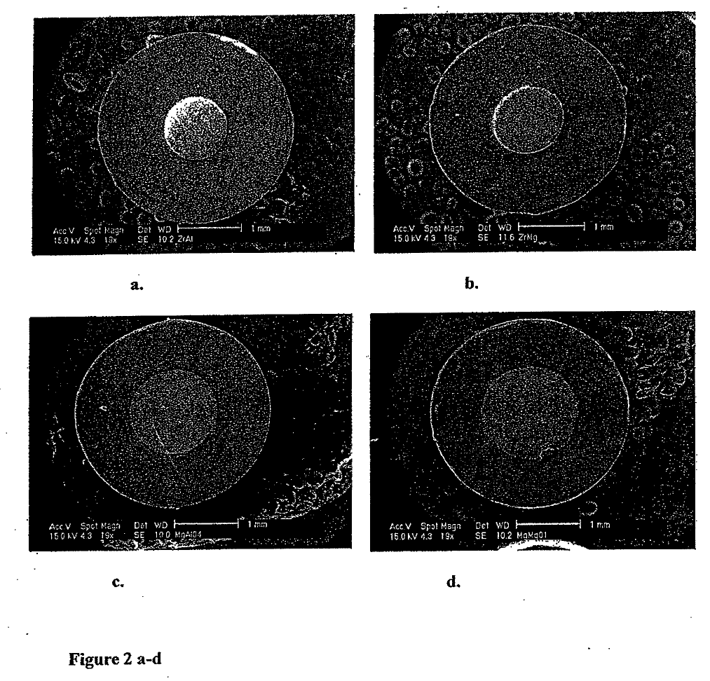

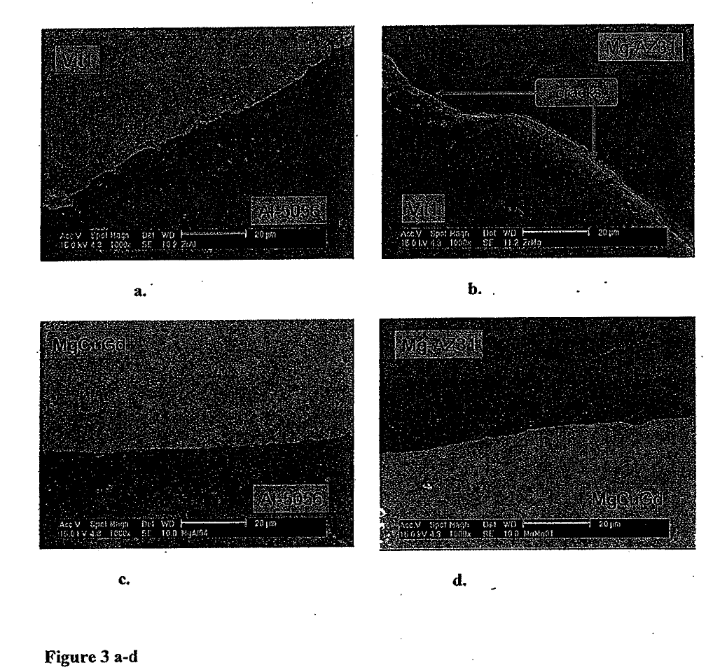

FIG. 1 shows typical pictures of two extruded rods: BMG 1/Al and BMG 2/Al. The surface of the rods is very smooth and no defect is observed along these rods demonstrating that extrusion has occurred in a satisfactory manner. Similar observations have been made for the two other types of MEGA rods. SEM observations of the cross sections of the co-extruded MEGA rods have been carried out as shown in FIG. 2. The diameters of the glass cores are not identical for the two glasses since their initial diameter was also different. One can note that, whatever the glass/alloy couple, the glass core is well centered in the rod. At this scale, the interfaces quality appears quite satisfactory. FIG. 3 shows SEM observations of the interfaces at a higher magnification for the four studied MEGA rods. For the BMG 1/Al, BMG 2/Al and BMG 2/Mg, the quality of the interfaces appears still fairly good, suggesting that a good bonding between the glass and the alloy has resulted from extrusion. The bond is not so good for the BMG 1/Mg rod since cracks can be detected along the interface.

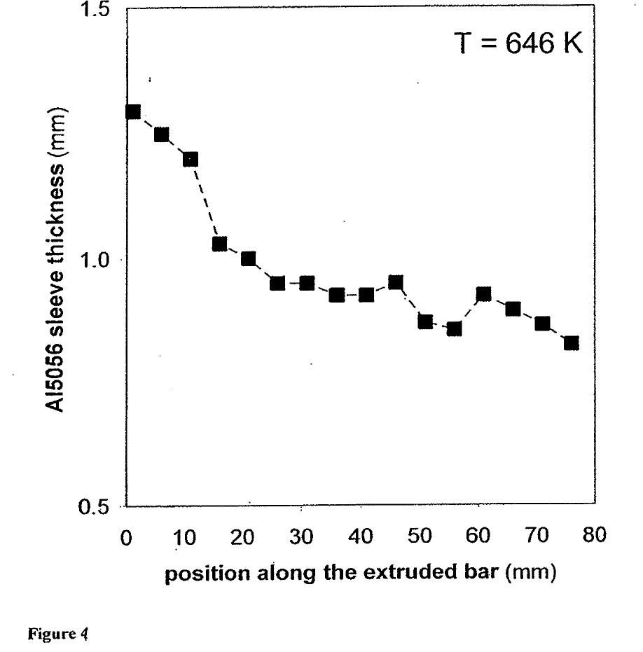

In order to check whether the two materials have been deformed in a similar way during extrusion, it was tempting to measure the dimension of the glass core of the rods from FIG. 1 and to compare it to the expected value deduced from its initial diameter and the extrusion ratio. The comparison would be valid provided that this dimension does not vary along the extruded rod. FIG. 4 displays the variation of the thickness of the sleeve in the case of the BMG 1/Al-5056 rod as a function of the position along the extruded rod, the origin being taken close to the die. The sleeve thickness decreases continuously as the distance from the die increases, which means that the diameter of the glass core is larger at the beginning of the extrusion and decreases with continuing extrusion. However, between distances of 20 mm and 60 mm along the rod (i.e. for a length of about 40 mm), the variation of the thickness remains very limited (+/−10%). Such a variation of the sleeve thickness along the rod is in agreement with previously published results in the case of conventional co-extrusion of bimetals [P. Kazanowski et al., Mater. Sc. Eng., 2004, A369, 170].

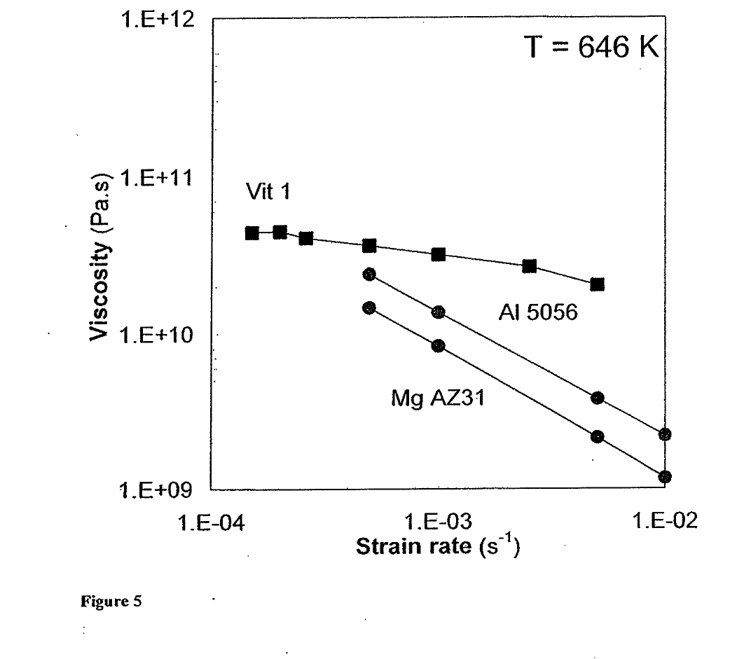

In the present study, the relative strengths of the various materials are not known. In order to evaluate the rheological behaviour of the materials during extrusion, strain rate jump tests in compression were carried out at 423 K and 646 K for strain rates ranging between 10⁻⁴ s⁻¹ to 10⁻² s⁻¹. FIG. 5 shows the variation with the applied strain rate of the viscosities (η=σ/3\dot{ε} with σ the flow stress recorded during compression after each strain rate jump and \dot{ε} the applied strain rate) of the BMG 1 and the two sleeve alloys at 646 K.

For the glass, a nearly Newtonian behaviour (i.e. viscosity independent of the strain rate) is obtained at low strain rate corresponding to the large deformability regime of the glass at this temperature. At high strain rates, however, a non-Newtonian behaviour progressively develops, associated with a reduction of the apparent viscosity as usually reported in the case of high temperature deformation of bulk metallic glasses [J. Lu, G. Ravichandran, W. L. Johnson, Acta Mater., 2003, 51, 3429; M. D. Demetriou, W. L. Johnson, Acta Mater., 2004, 52, 3403; M. Blétry et al., Acta Mater., 2006, 54, 1257]. For the two alloy sleeves, the viscosity decreases sharply with increasing strain rate. For the Al5056 alloy, a law of the form η=\acute{ε}^{-0.8} applies, which is equivalent to a strain rate sensitivity parameter m close to 0.2 if a power law creep is assumed (σ=K\dot{ε}^{m}), suggesting that the alloy deforms by dislocation creep as expected for such experimental conditions [R. Kaibyshev et al., Mater. Sc. Eng., 2005, A392, 373]. A quite similar behaviour is observed for the MgAZ31 alloy also in agreement with previously reported behaviours for this alloy [J. A. Del Valle et al., Metall Mater. Trans., 2005, 36A,1427; K. Ishikawa et al., J. Mater. Sc., 2005, 40, 1577-1582].

The interesting point is that, whatever the strain rate, the viscosity of the glass remains higher than the viscosity of the sleeve alloys. In order to estimate the average equivalent strain rate experienced during extrusion, the following formula proposed by [G. E. Dieter, Mechanical Metallurgy, SI Metric ed., Mc Graw Hill, London (1988)] can be used:

$$\dot{ɛ} = \frac{6 {VD}_{i}^{2} tg ɛ φ}{{D}_{i}^{3} - {D}_{f}^{3}} \qquad formula 1$$

where V is the ram speed, Di the initial diameter, D_{f} the final diameter, φ the angle of the conical die and ε the equivalent strain (ε=logRₑ with Rₑ the extrusion ratio). The studied experimental conditions lead to strain rates typically in the range [2×10⁻³ s⁻¹; 2×10⁻² s⁻¹]. For an applied strain rate of about 10⁻² s⁻¹, which corresponds roughly to the extrusion conditions for which the SEM observations have been carried out, a viscosity ratio of about 5 is measured for the BMG 1/Al-5056 rod whereas it is about 10 for the BMG 1/Mg-AZ31 rod.

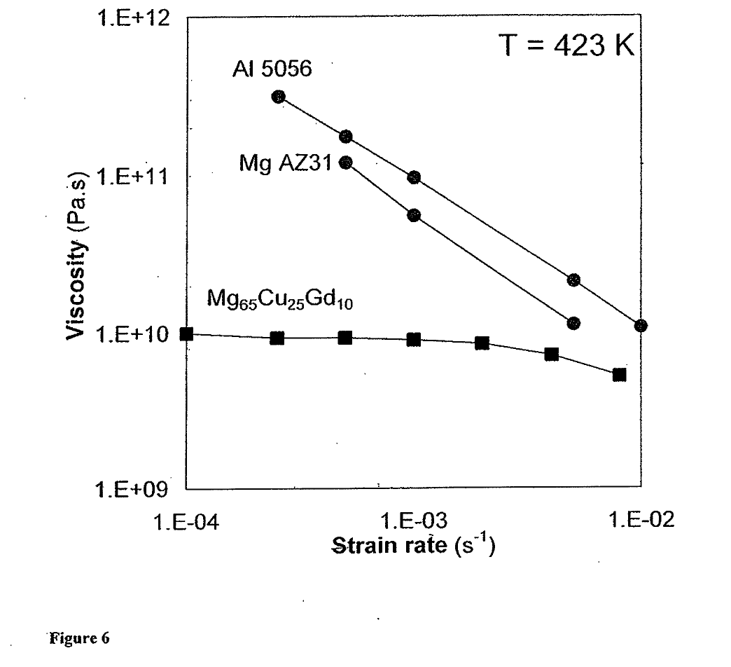

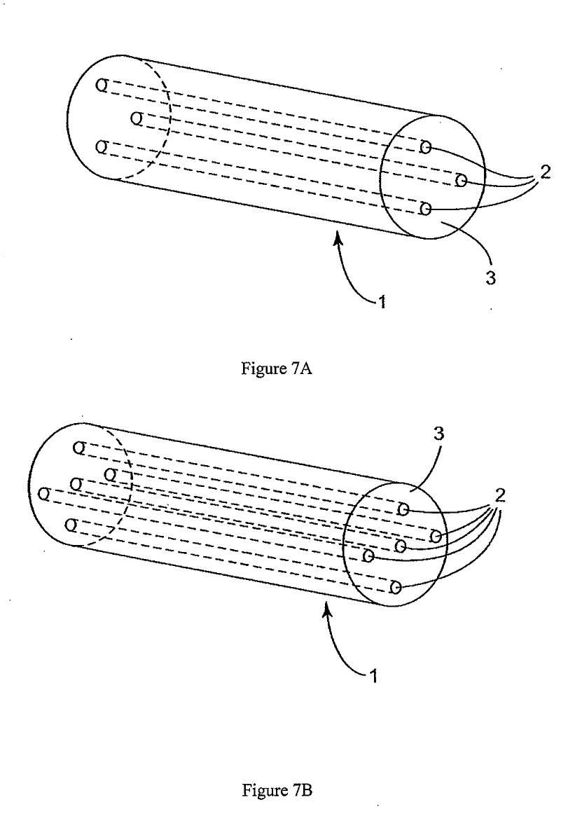

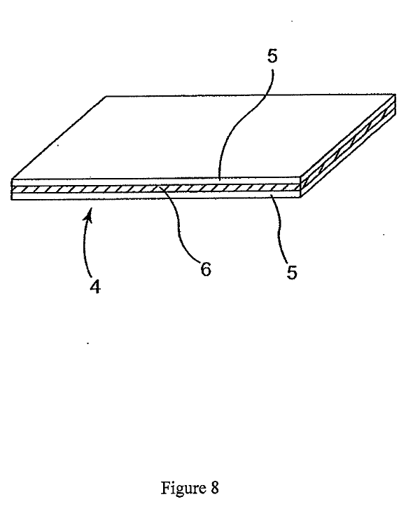

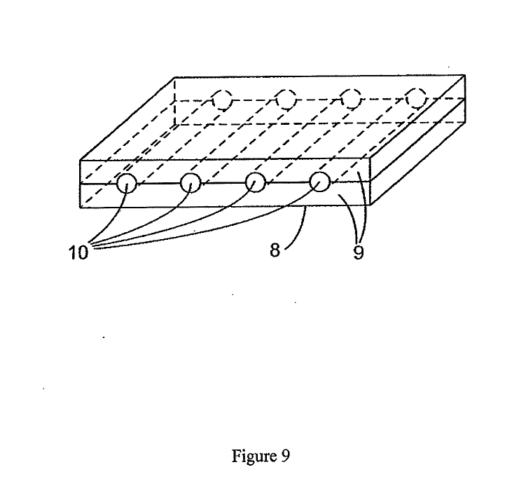

For the rods containing the Mg based BMG, the situation is quite different compared with the Zr based BMG. FIG. 6 shows the variation with the applied strain rate of the viscosities of the MgCuGd glass and the two sleeve alloys at 423 K. One can note that in a particularly large strain rate interval, this glass maintains a Newtonian behaviour. In the strain rate range of interest for extrusion, these compression tests suggest more similar viscosities for the glass core and the alloy sleeves than in the case of the BMG 1 core, the viscosity of the BMG 2 glass being even smaller than that of the sleeve alloys. Such a small viscosity difference between the glass and the sleeves is expected to affect the thickness distribution of the sleeve along the rods. This situation should be, therefore, more favourable to produce defect-free MEGA rods which is confirmed by the experiments carried out.

In order to get a preliminary estimate of the mechanical properties of the as-produced MEGA rods, some cylindrical specimens were machined from the extruded rods (3 mm diameter, 5 mm height) and tested in compression at room temperature with the stress axis parallel to that of the glass core. As already mentioned, the glass core diameters vary along the rods so that various glass volume fractions can be obtained for a given MEGA rod depending on the position of the compression sample along the rod. It is to be noted, however, that the specimen height was sufficiently small for the core diameter not to vary significantly in a specific specimen.

The glass volume fractions fᵥ corresponding to the tested samples are given in table III.

TABLE III
Comparison between experimental fracture stresses of
the produced MeGA-rods and values deduced from the rule of mixtures

| Composite rod | fᵥ | σ_{F} | σ_{MR} | σ_{F}/σ_{MR} |
|---|---|---|---|---|
| BMG 1/Al | 0.21 | 520 | 552 | 0.94 |
| BMG 1/Mg | 0.18 | 410 | 456 | 0.90 |
| BMG 2/Al | 0.57 | 560 | 505 | 1.11 |
| BMG 2/Mg | 0.35 | 475 | 371 | 1.28 |

Depending on the rods, fᵥ varies from 0.18 to 0.57. For all these samples, a macroscopically brittle behaviour was observed with fracture stresses σ_{F} ranging from 410 MPa (for the BMG 1/Mg-AZ31 rod) to 560 MPa (for the BMG 2/Al-5056 rod). However, after testing, no external fracture appeared on the sleeves, supporting the idea that fracture occurs systematically in the glass core. Since the stress axis is parallel to that of the glass core, isostrain behaviour can be assumed. By using the rule of mixtures, the stress of the MEGA rod σ_{MR} is given by:

σ_{MR}=f_{V}ν_{G}+(1−f_{V})σ_{A} formula 2

where σ_{A} and σ_{G} are the corresponding compressive strength in the alloy sleeve and the fracture stress in the glass rod respectively. In this preliminary work, the values of σ_{A} were directly deduced from microhardness measurements according to the frequently used relationship: σ≈3 HV. Microhardness measurements (200 gf applied during 15 s) were carried out in the sleeves after co-extrusion. The results are given in table IV and compared to the values measured before extrusion.

TABLE IV
Microhardness of the studied materials at various steps
of the extrusion process

| | | HV after | HV after |
|---|---|---|---|
| | HV before | extrusion at | extrusion at |
| Material | extrusion | 423 K | 626 K |
| BMG 1 | 600 | — | 595 |
| BMG 2 | 265 | 270 | — |
| Al 5056 | 74 | 104 | 75 |
| Mg AZ31 | 53 | 74 | 55 |

The variation of the hardness is closely related to the extrusion temperature. For extrusions carried out at 626 K, no significant variation of hardness is detected. This result can be probably attributed to the intense recovery which can take place in both alloys when they are deformed at this temperature at moderate strain rate. Conversely, when the alloys are deformed at 423 K, a significant strain hardening is expected, which is confirmed by the large hardness values compared to the values found before extrusion. Microhardness measurements were also carried out for the metallic glasses before and after extrusion (200 gf for the BMG 2 and 1000 gf for the BMG 1 applied during 15 s in both cases). The hardness of the glasses is not modified by extrusion confirming that they are still fully amorphous after extrusion and suggesting that their strengths are not significantly affected by the process. However, conversely to what was done for the sleeve alloys, these microhardness values can hardly be used to deduce the fracture stress of the glass in the MEGA rod. Consequently, compression tests were carried out on the glasses before extrusion, leading to fracture stresses of 1800 MPa and 650 MPa for the BMG 1 and the BMG 2 metallic glasses respectively.

From these measurements, predicted values of σ_{MR}, also given in table III, were calculated according to relation (2). The comparison with the values measured during compression of the tested MEGA rods is quantified thanks to the ratio σ_{F}/σ_{MR}. One can see that the predictions are in fairly good agreement with the experimental values knowing that the error on this ratio can be roughly estimated to ±10%.

Production of Multi-Filamentary Composites A15056/BMG 1 and Al 5056/BMG 2:

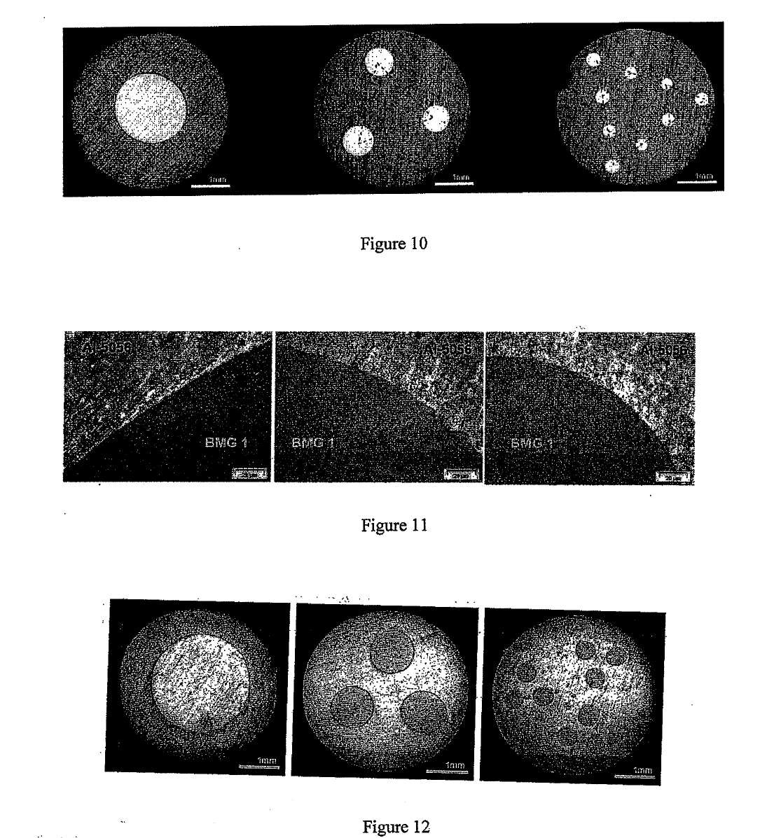

FIG. 10 shows OM observations of the cross sections of the co-extruded MEGA rods Al 5056/BMG 1 after one, two and three extrusions. One can notice that a particularly well controlled distribution of the BMG1 filaments can be achieved. Moreover, as the number of extrusions is increased, the mean diameter of the BMG1 filaments is reduced and the extent of this reduction is in accordance with the extrusion ratio. The interface quality appears also satisfactory, which was confirmed by observations at higher magnification, as illustrated by FIG. 11.

FIG. 12 shows OM observations of the cross sections of the co-extruded MEGA rods Al 5056/BMG 2 after one, two and three extrusions. As for co-extrusions involving BMG1, the interface quality in the case of Al-5056/BMG2 appears again satisfactory and a well controlled distribution of the filaments can be achieved.

Co-Extrusion of Mg-AZ31/BMG2 with a Die of Rectangular Shape

FIG. 14 shows an OM observation of the cross section of a co-extruded MEGA rod (Mg-AZ31/BMG2) after one extrusion carried out with the rectangular die. One can see that the shape of the BMG core is not so far from the external shape of the extruded component. Moreover, the area reduction of the BMG core during the extrusion process is in agreement with the extrusion ratio.

Resistivity Measurements:

In addition to measurements of mechanical properties of the co-extruded materials, four-point resistivity measurements were also carried out in the case of the Al 5056/BMG 1 co-extruded material. Two glass volume fractions fv close to 0.15 and 0.6, were tested. Knowing that the resistivity of the aluminium alloy chosen in this work is close to 80 nΩ.m (this relatively high resistivity value is directly linked to the composition of the alloy and in particular to the significant solute amount), the two studied co-extruded composites (with fv=0.15 and 0.6) displayed resistivity values of about 140 nΩ.m and 450 nΩ.m respectively. The fact that metallic glasses are not insulating materials (the measured resistivity of the studied glass is about 1800 nΩ.m) can be particularly attractive for high values of fv in comparison with the situation where insulating ceramic fibres would be used to reinforce an aluminium matrix.

As for the mono-filamentary composites, four-point resistivity measurements were also carried out in the case of multi-filamentary Al 5056/BMG 1 co-extruded material in order to evaluate the sensitivity of the electrical characteristics on the number of filaments. In order to perform a comparison for the same glass volume fraction, one specific co-extrusion was carried out at the same temperature and at the same ram speed in order to produce a mono-filamentary composite with the same glass volume fraction (fv=0.06) as the multi-filamentary composite with nine filaments which is shown in FIG. 10. The resistivity values of the composite materials were measured and they were found to differ by less than 10%, suggesting a limited effect of the number of filaments on the electrical characteristics of the co-extruded materials.

Co-Pressing of Multilayered Al-5056 with BMG3:

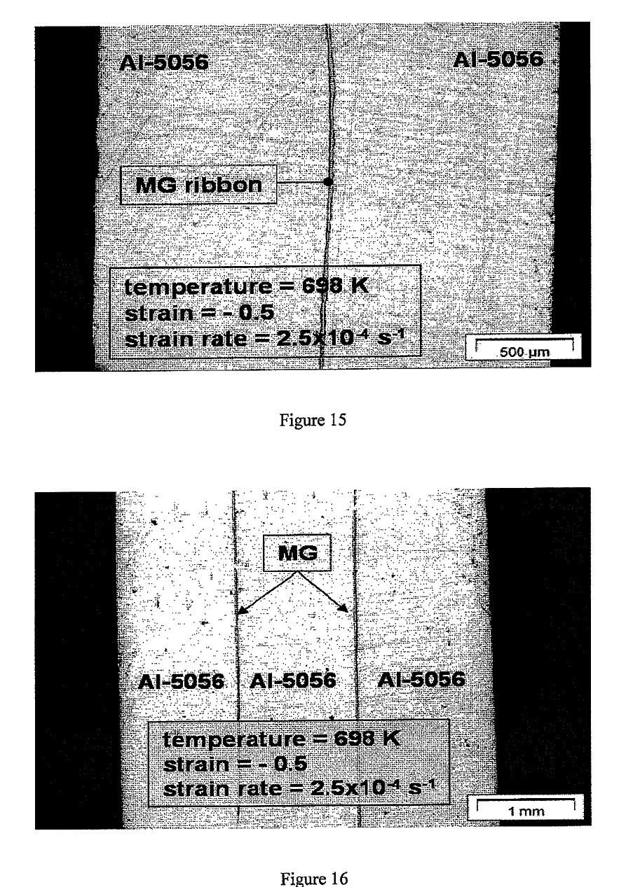

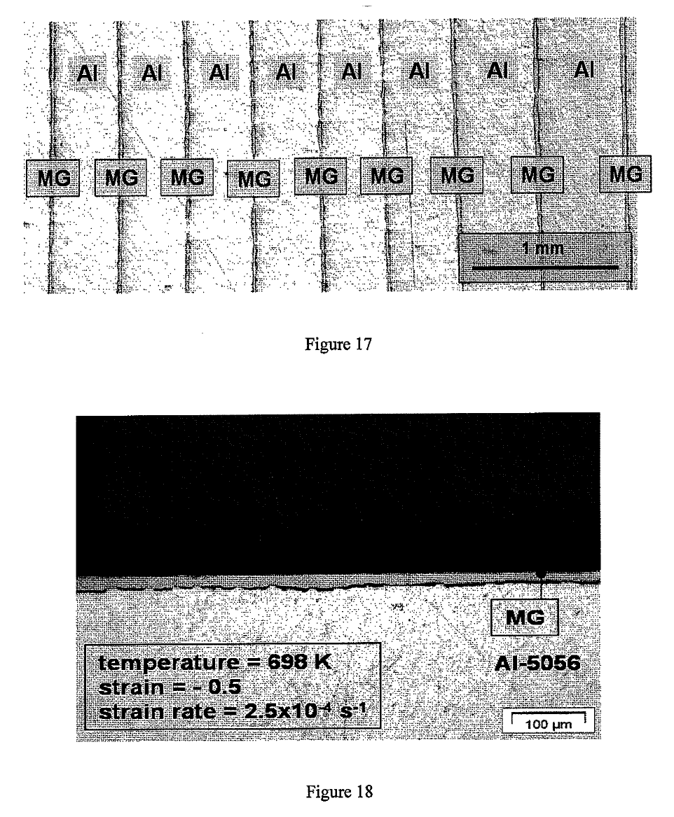

FIG. 15 displays an OM of the processed multi-material in the case of Al-5056/BMG3/Al-5056 plates. The glass ribbon has been deformed and its thickness is very homogeneous and in agreement with the imposed strain FIG. 16 displays an OM of the processed multi-material in the case of Al-5056/BMG3/Al-5056/BMG3/Al-5056 plates. FIG. 17 displays an OM of the processed multi-material in the case of stacking of ten Al-5056 plates with BMG3 ribbons in between. Whatever the processed material, the quality of the interfaces appears satisfactory.

Co-Pressing of Al-5056 with BMG3 for Al Coating:

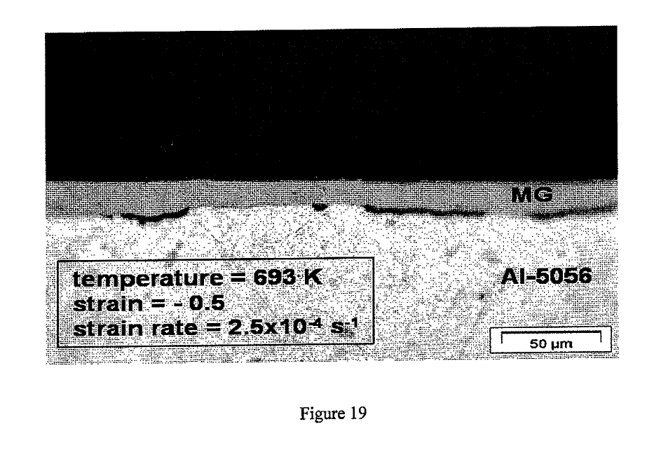

FIG. 18 illustrates a coating of BMG3 on an Al-5056 substrate. A square (5×5 mm2) plate of Al-5056 of 2 mm thickness was used together with a piece of ribbon of similar area. A continuous layer of BMG3 on the aluminium substrate can be observed with no apparent porosity between this layer and the substrate. The thickness of the layer is relatively constant, typically of about 20 μm which is in agreement with the applied conditions of deformation and the initial thickness of the metallic glass ribbon. One can note that all the results were obtained despite the fact that the co-pressing experiments were carried out in air. It is the reason why some oxide phases can be detected at the BMG/Al interface (FIG. 19). A way to reduce such oxides would be to perform the pressing tests under vacuum or at least under inert gas.

1) A method for the production of a composite of at least one bulk metallic glass and at least one metal, wherein said method comprises the step of co-deforming the bulk metallic glass and the metal at a temperature comprised in the supercooled liquid region of the bulk metallic glass.

2) A method according to claim 1 wherein Tₘ is the melting temperature of the metal expressed in Kelvin and the co-deforming is performed at a temperature T_{d}, expressed in Kelvin, comprised between 0.4 Tₘ and 0.6 Tₘ.

3) A method according to claim 1 wherein the melting temperature of the metal, Tₘ, expressed in Kelvin, and the glass transition temperature, T_{g}, of the bulk metallic glass, also in Kelvin, satisfy the relationship:
0.4 Tₘ≦T_{g}≦0.6 Tₘ

4) A method according to claim 1 wherein the bulk metallic glass has a viscosity V_{MG} at the temperature at which the co-deformation is performed, and the metal has a viscosity V_{M} at the temperature at which the co-deformation is performed and they satisfy the relationship:
V_{MG}/10≦V_{M}≦10V_{MG}

5) A method according to claim 1 wherein co-deforming is co-extruding.

6) A method according to claim 5, wherein the method comprises:
(a) casting filaments or rods or tapes of bulk metallic glass,
(b) machining at least one hole in a metal rod or in a metal plate, along the central axis of the rod, or the central plane of the plate,
(c) heating the extrusion device to a temperature comprised in the supercooled liquid region of the bulk metallic glass,
(d) introducing the rod(s) or tape(s) of bulk metallic glass into the metal rod or plate,
(e) introducing the item obtained at (d) into the extrusion device,
(f) co-extruding a bulk metallic glass/metal composite.

7) A method according to claim 1, wherein it comprises introducing the bulk metallic glass and the metal in a press at an appropriate temperature and co-pressing the composite.

8) A method according to claim 7, wherein it comprises:
(a) casting filaments or rods or tapes of bulk metallic glass,
(b) heating the press to a temperature comprised in the supercooled liquid region (SLR) of the glass,
(c) stacking alternatively one or several rod(s) or tape(s) of glass metal with metal rod or plate(s),
(d) introducing the item obtained at (c) into the press,
(e) co-pressing of a glass metal/metal composite.

9) A method according to claim 7, wherein it comprises:
(a) casting filaments or rods or tapes or plates of bulk metallic glass,
(b) casting a metal plate,
(c) heating the press to a temperature comprised in the supercooled liquid region (SLR) of the glass,
(d) stacking alternatively one or several rod(s) or tape(s) of glass metal with metal rod or plate(s),
(e) introducing the item obtained at (d) into the press,
(f) co-pressing of a glass metal/metal composite.

10) A method according to claim 1, wherein it comprises introducing the bulk metallic glass and the metal in a rolling mill at an appropriate temperature and co-laminating the composite.

11) A method according to claim 10 wherein it comprises:
(a) casting plates of bulk metallic glass,
(b) casting metal plates,
(c) heating the metal and glass metal plates to a temperature comprised in the supercooled liquid region (SLR) of the glass,
(d) introducing the plates of glass metal between two metal plates,
(e) introducing the item obtained at (d) between the rolls,
(f) co-laminating of a glass metal/metal composite.

12) A composite material resulting from the co-deformation of a bulk metallic glass and a metal.

13) A composite material according to claim 12, wherein the bulk metallic glass is selected from those based on: Mg, Zr, Fe, Pd, Cu, Ti, Ni, Ca, Pd, Mo, Cr, Co, Pt, Gd, La, Ce

14) A composite material according to claim 13, wherein the bulk metallic glass is selected from those based on: Zr, Mg, Ti, Fe, Ni, Cu.

15) A composite material according to claim 12, wherein the bulk metallic glass comprises 3, 4 or 5 elements.

16) A composite material according to claim 12, wherein the metal is selected from wrought metals and wrought alloys.

17) A composite material according to claim 16, wherein the metal is selected from Al, Mg and Cu based alloys.

18) A composite material according to claim 12, wherein it has a core/sleeve structure with a bulk metallic glass core and a metal sleeve.

19) A composite material according to claim 12, wherein it has a structure comprising several parallel bulk metallic glass cores and a metal sleeve.

20) A composite material according to claim 12, wherein it has a sandwich structure comprising two metal plates and a bulk metallic glass plate included in between the metal plates.

21) A composite material according to claim 12, wherein it has a structure comprising two metal plates and parallel bulk metallic glass rods inserted in between the metal plates.

22) A composite material according to claim 12, wherein it has a structure comprising one metal plates and a bulk metallic glass plate coated on the metal plate.

23) An electricity conducting structure wherein it includes a composite material according to claim 12.

24) An electricity conducting structure according to claim 23 wherein it comprises a bulk metallic glass core and a metal sleeve.
